(19) United States
(12) Patent Application Publication
(10) Pub. No.: US 2006/0034332 A1
(43) Pub. Date: Feb. 16, 2006

(54) Multiplexed transmission system, multiplexed transmission apparatus, its program and recording medium

(76) Inventor: Kenichi Haga, Takatsuki-shi (JP)

Correspondence Address: MCDERMOTT WILL & EMERY LLP, 600 13TH STREET, N.W., WASHINGTON, DC, 20005-3096, US

(21) Appl. No.: 11/189,039

(22) Filed: Jul. 26, 2005

(30) Foreign Application Priority Data
Jul. 27, 2004 (JP) P2004-218293

(51) Int. Cl. H04J 3/24

(52) U.S. Cl. 370/474

(57) ABSTRACT

By having a control information dividing section which divides control information in such a manner that an expiration value of its response wait timer and a division size become an inverse relation, and an encoding method selecting section 14 which selects such an encoding method that media information becomes maximum transfer efficiency within a range excluded a division size of control information, a division size is enlarged at the time of transmitting control information with high urgency to suppress transmission delay, whereas a division size is reduced at the time of transmitting control information with low urgency to allow transmission delay, and it is possible to improve quality of media information for that much.

### BACKGROUND OF THE INVENTION

1. Field of the Invention

This invention relates to a multiplexed transmission method, a multiplexed transmission apparatus, and its program and recording medium, which are suitable for a television telephone system and a television telephone apparatus, in which a plurality of media information such as sounds/images and control information are multiplexed to be transmitted.

2. Description of the Related Art

In a television telephone service which is provided in W-CDMA type portable telephones, a recommendation, which is described in ITU-T Recommendation H.324, is applied as a specification for realizing the service. In a television telephone apparatus implemented in relation to the above-described recommendation, as a specification for exchanging control information between a plurality of apparatuses, a recommendation, which is described in ITU-T Recommendation H.245, is applied, and as a specification for multiplexing media information such as sounds/images and control information, a recommendation, which is described in ITU-T Recommendation H.223, is applied.

In control information which is provided by the recommendation described in the ITU-T Recommendation H.245, there is one which needs a response from an opposite station like a logical channel opening request (Open Logical Channel) etc. A transmission side of these control information has to activate a timer for monitoring a response from an opposite station at the same time as transmission, and to receive a response until it is expired, and therefore, in order to avoid abnormal processing due to timer expiration, there is need to mitigate transmission delay, by securing preferentially a transmission band rather than media information such as sounds/images and multiplexing it.

Here, with respect to a method and an apparatus which secures preferentially a transmission band of specific media information rather than other media information and multiplexes and transmits it, an invention, like one described in JP-A-2003-250133 publication, is made in the past. In that invention, a difference of all information quantity of a multiplexed frame to be transmitted per a transmission cycle and information quantity of media with high priority to be transmitted per a transmission cycle is obtained, and multiplexed transmission is carried out in such a manner that media information quantity with low priority falls within a range of the above-described difference.

In addition, JP-A-11-313048 publication describes an invention relating to a multiplexed transmission method in case that a band of an entire transmission path fluctuated due to disturbance etc., and an encoding method of each media information is changed over in such a manner that a total of all media information quantity fits into a range of an entire transmission path, and control information, which shows a changed encoding method is multiplexed together with media information and is transmitted. Here, if an invention described in JP-A-11-313048 publication is applied to other media information considering control information as a factor of band fluctuation, a band for control information is secured preferentially and it is possible to multiplex and transmit it.

However, if it is tried to apply a method described in the above-described Patent Documents in order to preferentially secure a transmission band of control information, it is expected that a problem as follows will occur.

JP-A-2003-250133 publication handles such a thing that a transmission cycle was defined (sound) as media information with high priority, and therefore, if it is tried to apply a method described in the JP-A-2003-250133 as it is, in order to preferentially secure a transmission band of control information in which a transmission cycle is not defined, it is expected that, as shown in FIG. 9, a useless open area is generated in a multiplexed frame, when control information to be transmitted does not exist, and a transmission band is not utilized effectively.

That is, if a high priority information area is secured in multiplexed frames 1, 2, 3 shown in FIG. 9 (b) in order to preferentially transmit control information shown in FIG. 9 (a), a useless open area is generated in a transmission band when control information to be transmitted does not exist, as shown in a shaded portion of the multiplexed frames 2, 3.

On one hand, if the invention, which is described in JP-A-11-313048, is applied, it can be expected that a useless open area in a multiplexed frame as described above is eliminated, but a transmission band of media information fluctuates every time control information to be transmitted occurs, and therefore, control information, which shows a changed encoding method, is to be multiplexed by addition, and a transmission band of media information such as sounds/images is to be oppressed by that much.

In particular as shown in FIG. 10, in case that control information, which shows a changed encoding method, is transmitted across a plurality of multiplexed frames, a decoding method is changed over on the basis of the above-described control information on a reception side, and therefore, media information, which was multiplexed at the same time, is stayed only for a period of necessary time for receiving all of the above-described plurality of multiplexed frames, so that quality is to be lowered.

That is, in case that control information 2, which represents a changed encoding method shown in FIG. 10 (b), is multiplexed together with control information 1 shown in FIG. 10 (a), the control information 2 is multiplexed with three multiplexed frames which will be described later, by addition. On this account, an areas for that purpose has to be secured in a multiplexed frame, so that a band of media information is oppressed. In addition, it takes three transmission cycles that the changed encoding method is conveyed to an opposite station, and therefore, media information for three transmission cycles is stayed so that quality is lowered.

### SUMMARY OF THE INVENTION

The invention is one which was made in view of the above-described circumstance, and its object is to provide a multiplexed transmission method, a multiplexed transmission apparatus, its program and recording medium, by which it is possible, over preferentially securing a transmission band for transmitting control information, to suppress lowering of transmission quality of other media information due to it, to the minimum.

A multiplexed transmission method of the invention is a multiplexed communication method which multiplexes a frame having media information and control information to transmit and receive it, comprises the steps of dividing the control information, depending on a length of response wait available which is defined with respect to each control information, securing a size of the control information which was divided in the dividing step, in the frame, and encoding the media information such that a size of the media information after encoding becomes equal to or less than a size which is obtained by subtracting a size secured in the securing step from a size of the frame.

According to the multiplexed transmission method of the invention, control information is divided on the basis a saturation value of a response wait timer, and a division size area of control information is secured preferentially in a multiplexed frame, and therefore, it is possible, over preferentially securing a transmission band for transmitting control information, to suppress lowering of transmission quality of other media information due to it, to the minimum.

In addition, a multiplexed transmission method of the invention is characterized in that, the shorter a length of the response wait available time is, the more the dividing step enlarges a size of the control information which is divided in the dividing step.

According to a multiplexed transmission method of the invention, control information, in which an expiration value of a response wait timer is small, is considered to require an immediate response, and a division size of control information is enlarged, and therefore, it is possible to reduce transmission delay of control information. On one hand, control information, in which the expiration value of the response wait timer is large, is considered not to require such an immediate response, and the division size of control information is reduced, and therefore, it is possible to widely secure a transmission band of media information by that much, and it is possible to suppress influence to quality of sounds/images, to the minimum.

In addition, a multiplexed transmission method of the invention is characterized in that, as to the dividing step, in case that the control information which is transmitted, is not required to be received, a size of the divided control information is made smaller than such a case that the control information which is transmitted, is required to be received.

According to the multiplexed transmission method of the invention, in case that control information to be transmitted is a response to control information which was received from an opposite station, a division size of the control information to be transmitted is enlarged, and therefore, it is possible to reduce transmission delay of control information. On one hand, in case that the control information to be transmitted is information which does not need a response from an opposite station, a division size of the control information to be transmitted is enlarged, and therefore, it is possible to suppress influence to quality of sounds/images to the minimum.

In addition, a multiplexed transmission method of the invention is characterized by comprising the steps of deciding one encoding method among one or more encoding methods which are available on the occasion of encoding the media information, on the basis of a size of the media information, transmitting the control information including information which shows the one encoding method decided in the deciding step, restraining decoding of the media information, in case that a size of the media information is different from a size of already received media information, when the media information is received,

selecting a decoding method, on the basis of the control information including the information which shows the one encoding method transmitted in the transmitting step, and

decoding the restrained media information, by use of the selected decoding method, after the decoding method is selected in the step of selecting the decoding method.

According to the multiplexed transmission method of the invention, in case that a rate of media information in the received multiplexed frame is different from a rate of media information in a multiplexed frame which was received previous time, a decoding method, which corresponds to an encoding method notified from an opposite station during a call sending/receiving period, is selected on the basis of a rate of media information which was obtained this time, and therefore, it is possible to reduce transmission delay of control information, and to suppress lowering of transmission quality of media information, to the minimum.

In addition, a multiplexed transmission apparatus of the invention is a multiplexed communication apparatus which multiplexes a frame having media information and control information to transmit and receive it, comprising a control information generating section which generates the control information, a control information dividing section which divides the control information, depending on a length of a response wait available time which is defined with respect to each control information, an encoding method selecting section which selects such an encoding method that a size of the media information after encoding becomes equal to or less than a size which is obtained by subtracting a size of the control information divided in the control information division section from a size of the frame, and a multiplexing section which multiplexes the encoded media information and the divided control information, by the encoding method which is selected in the encoding method selecting section.

According to the multiplexed transmission apparatus of the invention, control information is divided on the basis a saturation value of a response wait timer, and a division size area of control information is secured preferentially in a multiplexed frame, and therefore, it is possible, over preferentially securing a transmission band for transmitting control information, to suppress lowering of transmission quality of other media information due to it, to the minimum.

In addition, in the multiplexed transmission apparatus of the invention, it is characterized the shorter a length of the response wait available time is, the more the control information dividing section enlarges a size of the divided control information.

According to the multiplexed transmission apparatus of the invention, control information, in which an expiration value of a response wait timer is small, is considered to require an immediate response, and a division size of control information is enlarged, and therefore, it is possible to reduce transmission delay of control information. On one hand, control information, in which the expiration value of the response wait timer is large, is considered not to require such an immediate response, and the division size of control information is reduced, and therefore, it is possible to widely secure a transmission band of media information by that much, and it is possible to suppress influence to quality of sounds/images, to the minimum.

In addition, in the multiplexed transmission apparatus of the invention, it is characterized that the control information dividing section reduces a size of the divided control information more in case that the control information to be transmitted is not necessary to be received, than in case that the control information to be transmitted is necessary to be received.

According to the multiplexed transmission apparatus of the invention, in case that control information to be transmitted is a response to control information which was received from an opposite station, a division size of the control information to be transmitted is enlarged, and therefore, it is possible to reduce transmission delay of control information. On one hand, in case that the control information to be transmitted is information which does not need a response from an opposite station, a division size of the control information to be transmitted is enlarged, and therefore, it is possible to suppress influence to quality of sounds/images to the minimum.

In addition, in the multiplexed transmission apparatus of the invention, it is characterized that the encoding method selecting section selected one encoding method, among one or more encoding method which are available on the occasion of encoding the media information.

According to the multiplexed transmission apparatus of the invention, all types of encoding methods which can be used by the encoding section are set up in control information, and therefore, on a reception side, it is possible to recognize an encoding method which was used by the encoding section and a decoding method which corresponds to it, from received control information.

In addition, a multiplexed transmission apparatus of the invention is characterized to be equipped with a decoding method selecting section which restrains decoding the media information, in case that a size of the media information is different from a size of already received media information, when the media information is received, and selects a decoding method, on the basis of the control information including information which shows the one encoding method selected in the encoding method selecting section; and a decoding section which decodes the media information and the control information, by use of a decoding method which was selected in the decoding method selecting section.

According to the multiplexed transmission apparatus of the invention, in case that a ratio of media information in the received multiplexed frame is different from a ratio of media information in a multiplexed frame which was received previous time, a decoding method, which corresponds to the encoding method notified from an opposite station during a call sending/receiving period, is selected on the basis of the ratio of media information which was obtained this time, and therefore, it is possible to reduce transmission delay of control information, and to suppress lowering of transmission quality of media information to the minimum.

According to the invention, at the time of transmission of control information which requires an immediate response, it is possible to reduce transmission delay by reducing a division number, and to reduce influence which is given to transmission delay by a size of control information.

On one hand, at the time of transmission of control information which does not require an immediate response, or when there is no control information to be transmitted, a percentage which is occupied by control information in a multiplexed frame, and therefore, it is possible to improve transmission quality by that much, by change over of an encoding method.

### BRIEF DESCRIPTION OF THE DRAWINGS

FIG. 1 is a block diagram which shows a schematic configuration of a multiplexed transmission apparatus for explaining a mode for carrying out the invention.

FIG. 2 is a sequence diagram which represents a flow of processing of a transmission side apparatus in the multiplexed transmission apparatus for explaining the mode for carrying out the invention.

FIG. 3 is a sequence diagram which represents a flow of processing of a reception side apparatus in the multiplexed transmission apparatus for explaining the mode for carrying out the invention.

FIG. 4 is a view which shows one example of combinations of encoding methods of sounds/images and transmission rates which can be used at the same time, in the multiplexed transmission apparatus for explaining the mode for carrying out the invention.

FIG. 5 is a view which shows a relation of a response wait timer and a division size of control information, in the multiplexed transmission apparatus for explaining the mode for carrying out the invention.

FIG. 6 is a view which shows one example of a configuration of a multiplexed frame to be generated, in the multiplexed transmission apparatus for explaining the mode for carrying out the invention.

FIG. 7 is a flow chart which represents processing of a transmission side in a program m which relates to the best mode for carrying out the invention.

FIG. 8 is a flow chart which represents processing of a reception side in the program which relates to the best mode for carrying out the invention.

FIG. 9 is a view for explaining problems which are envisioned in case that a method described in JP-A-2003-250133 is tried to be applied, for the purpose of preferentially multiplexing/transmitting control information.

FIG. 10 is a view for explaining problems which are envisioned in case that a method described in JP-A-11-313048 is tried to be applied, for the purpose of preferentially multiplexing/transmitting control information.

### DESCRIPTION OF THE PREFERRED EMBODIMENTS

Hereinafter, a multiplexed transmission apparatus, which relates to the best mode for carrying out the invention, will be described in detail with reference to drawings.

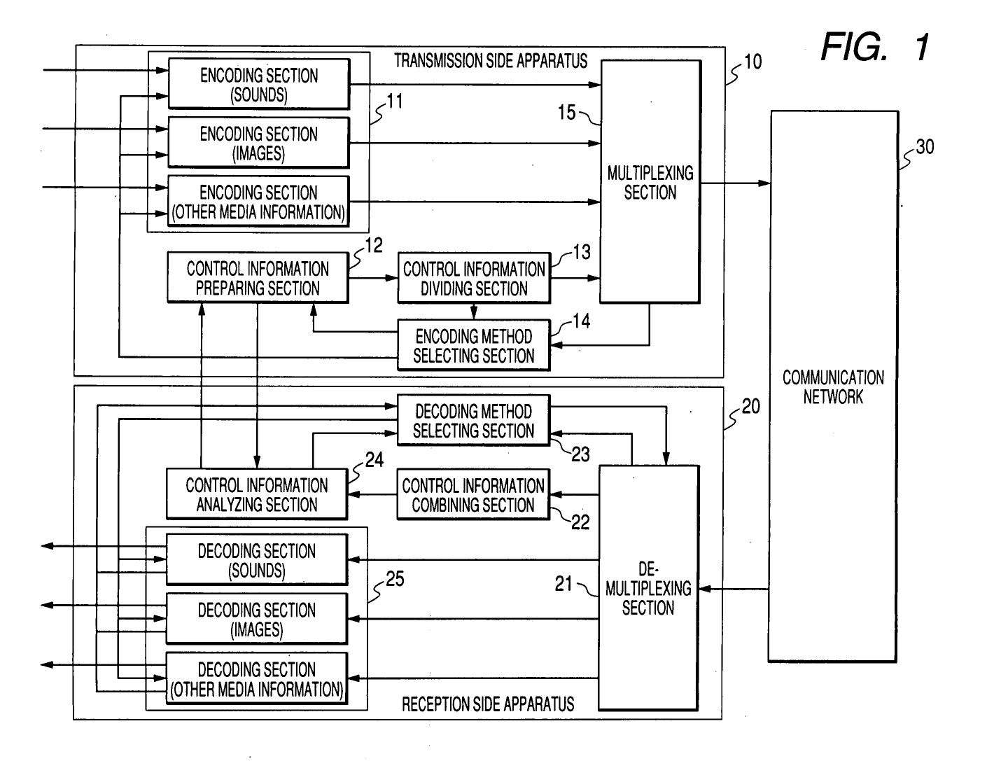

FIG. 1 shows a schematic configuration of a multiplexed transmission apparatus which relates to this mode. The multiplexed transmission apparatus, which relates to this mode, is equipped with a transmission side apparatus 10 which encodes/multiplexes various media information and control information and transmits it to an opposite station through a communication network 30, and a reception side apparatus 20 which de-complexes/decodes various media information and control information from an opposite station through the communication network 30.

The transmission side apparatus 10 is equipped with an encoding section 11 which encodes media information such as sounds/images/others which was inputted from a microphone/a camera etc., on the basis of a specified encoding method, a control information preparing section 12 which prepares and outputs control information, a control information dividing section 13 which divides the control information, an encoding method selecting section 14 which selected an optimum encoding method of media information such as sounds/images/others, on the basis of a multiplexed frame length and a division length of control information, and a multiplexing section 15 which multiplexes the encoded media information such as sounds/images/others and the divided control information and transmits it to an opposite station through the communication network 30.

Here, it is assumed that the control information dividing section 13 is implemented in relation to Annex C.8.1 (Control Channel Segmentation and Reassembly Layer) of the ITU-T Recommendation H.324.

On one hand, the reception side apparatus 20 is equipped with a de-multiplexing section 21 which de-multiplexes various media information and control information which were received from an opposite station through the communication network 30, a control information combining section 22 which combines the de-multiplexed control information into one complete control information, a decoding method selecting section 23 which selects an appropriate method for decoding the de-multiplexed various media information, a control information analyzing section 24 which analyzes a content of the combined control information and carries out processing which corresponds to the content, and a decoding section 25 which decodes various media information on the basis of a specified decoding method and outputs it to a speaker/LCD etc.

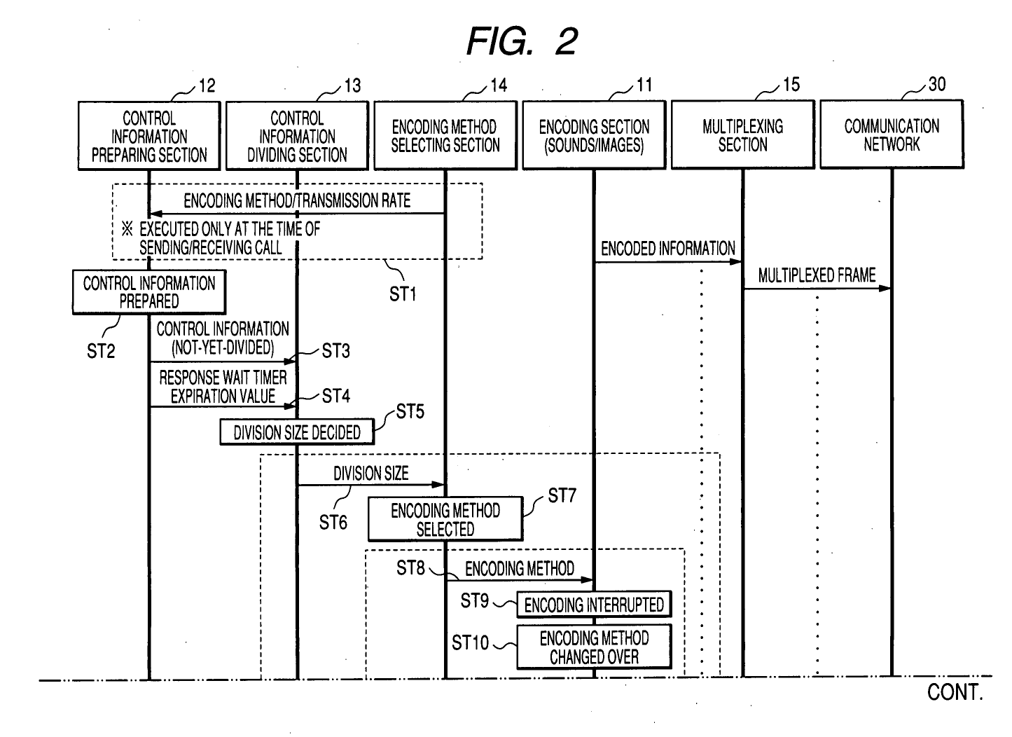

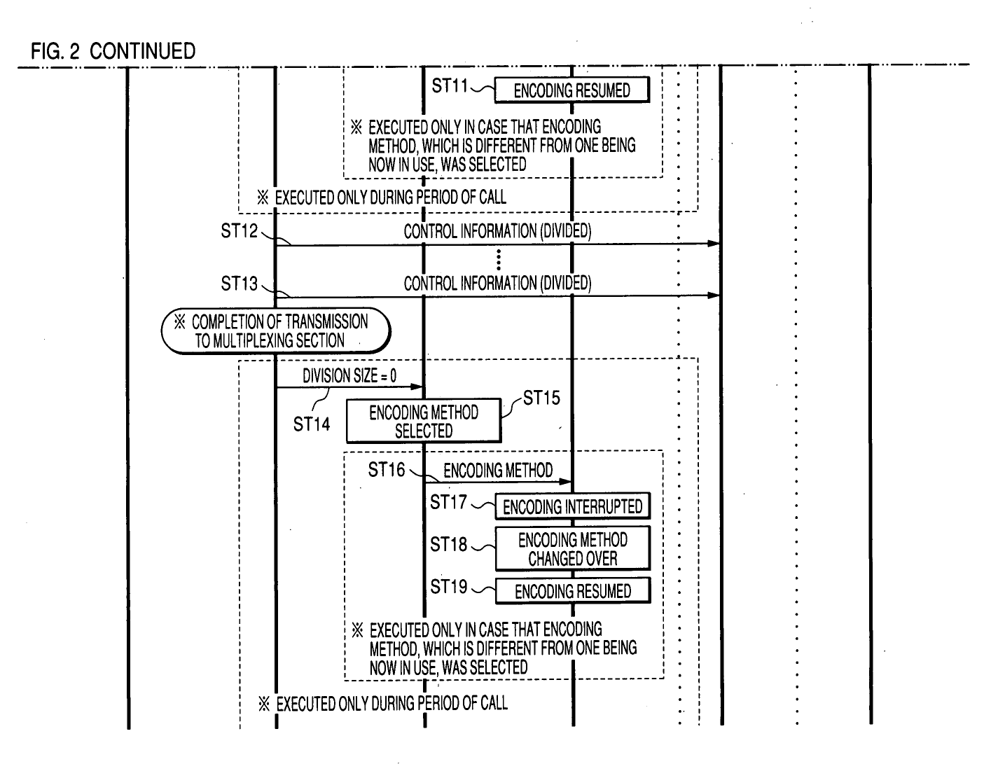

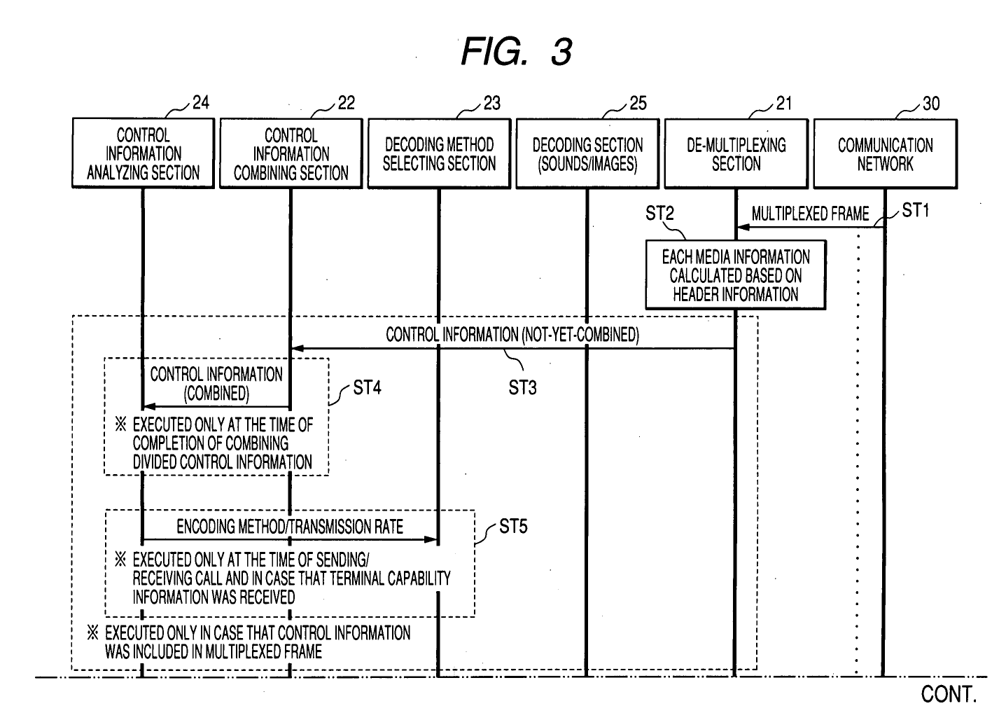

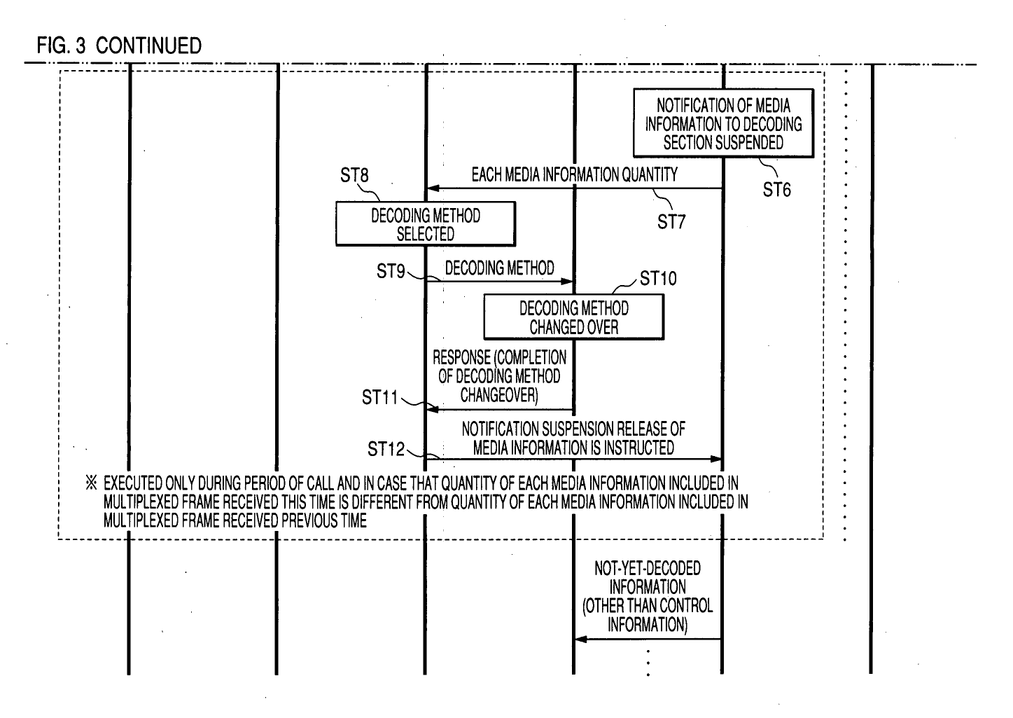

A multiplexed transmission method of various media information and control information by a multiplexed transmission apparatus with the configuration as described above will be described by citing a concrete example. FIG. 2 shows a flow of processing of the transmission side apparatus 10, and FIG. 3 shows a flow of processing of the reception side apparatus 20. In a concrete example here, it is assumed that media information to be handled is of only 2 types of sounds/images.

[Flow of Processing of Transmission Side Apparatus at the Time of Sending/Receiving Call]

Firstly, at the time of sending/receiving a call, the encoding method selecting section 14 notifies all of combinations of encoding methods of sounds/images which can be used at the same time and respective transmission rates, to the control information preparing section 12 (step ST1 of FIG. 2). The control information preparing section 12 sets up the combinations of encoding methods of sounds/images and respective transmission rates, which were notified from the encoding method selecting section 14, in control information for use in exchanging terminal capability information (which is comparable to Terminal Capability Set defined in the ITU-T Recommendation H.245(step ST2 of FIG. 2), and transmits them to an opposite station through the control information dividing section 13 and the multiplexing section 15 (concrete processing contents of the control information dividing section 13 and the multiplexing section 15 will be described later).

[Flow of Processing of Reception Side Apparatus at the Time of Sending/Receiving Call]

On one hand, a control information analyzing section 24 on the side of an opposite station, when it receives control information for terminal capability information exchange through the de-multiplexing section 21 and the control information combining section 22 (concrete processing contents of the de-multiplexing section 21 and the control information combining section 22 will be described later), notifies all of combination of encoding system of sounds/images which are set up in control information and respective transmission rates, to the decoding method selecting section 23 (step ST5 of FIG. 3). The decoding method selecting section 23 stores all of the combination notified from the control information analyzing section 24, until the time of clearing a call.

[Combination of Encoding Method and Transmission Rate]

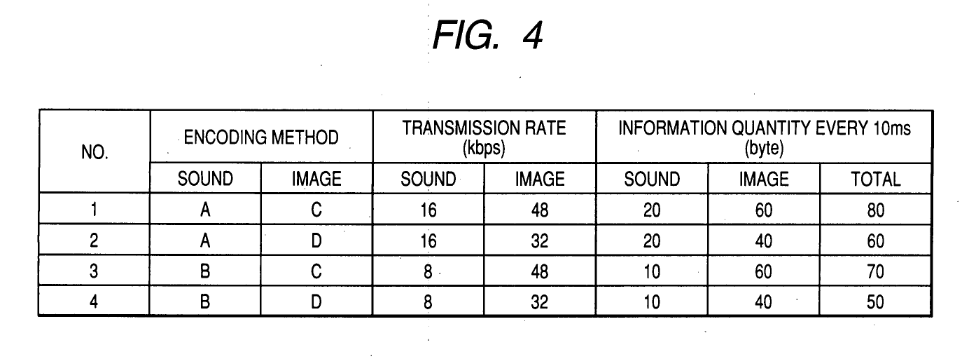

Here, one example of combination of an encoding method of sounds/images and a transmission rate is shown in FIG. 4. Sound encoding methods A, B, which are shown in FIG. 4, are comparable to, for example, 3G-AMR, G.723.1, and so on. In addition, image encoding methods C, D are comparable to, for example, MPEG-4, H.263 and so on.

Multiplexed transmission of each media information and control information during a period of call is carried out by the following procedures, on the basis of combination of encoding methods of sounds/images which were exchanged between an own station and an opposite station by the above-described procedure at the time of sending/receiving a call and respective transmission rates.

[Flow of Processing of Transmission Side Apparatus at the Time of Call]

A flow of processing of the transmission side apparatus 10 during a period of call will be hereinafter described. The control information preparing section 12, when it completed preparation of control information (step St2 of FIG. 2), outputs the control information together with an expiration value of its response wait timer to the control information dividing section 13 (step ST3 and step ST4 of FIG. 2). Citing control information which is defined in the ITU-T Recommendation H.245 as an example, when Terminal Capability Set is transmitted, an expiration value of T101 is outputted, and when Open Logical Channel is transmitted, an expiration value of T103 is outputted, to the control information dividing section 13, together with the control information, respectively.

[Case that Control Signal to be Transmitted is Response]

Control information, in which a response wait timer is not defined, will be handled as follows. In case that control information to be transmitted is a response itself to control information which was received at the last minute (citing control information defined in the ITU-T Recommendation H.245 as an example, Terminal Capability Set Ack and Open Logical Channel Act etc. are comparable to this), it is assumed that a value of a timer, which is outputted to the control information dividing section 13, is a minimum possible value.

For example, in case that a multiplexed transmission apparatus, which relates to the invention, is implemented in such a manner that a response wait timer is realized by 8 bit width and the minimum value becomes 1, 0x01 is outputted as a value of the timer to the control information dividing section 13. By doing so, the control information is divided as described later, in such a manner that transmission delay becomes minimum.

[Case that Control Signal to be Transmitted does not Need Response]

In case that control signal to be transmitted is used as a notification and an instruction which do not need a response from an opposite station (citing control information defined in the ITU-T Recommendation H.245 as an example, H223 Skew Indication and End Session Command etc. are comparable to this), it is assumed that a value of a timer, which is outputted to the control information dividing section 13, is a maximum possible value.

For example, in case that a multiplexed transmission apparatus, which relates to the invention, is implemented in such a manner that a response wait timer is realized by 8 bit width and the minimum value becomes 65535, 0xFF is outputted as a value of the timer to the control information dividing section 13. By doing so, the control information is divided as described later, in such a manner that transmission delay becomes maximum (influence to quality of sounds/images is suppressed to the minimum for that much).

[Division Size of Control Information is Decided]

The control information dividing section 13, when control information and an expiration value of its response wait timer are inputted from the control information preparing section 12 thereto, decides a division size of control information on the basis of the expiration value of the response wait timer (step ST5 of FIG. 2), and then, divides the control information. The divided control information is outputted to the multiplexing section 15 one by one at the same cycle as a transmission cycle of a multiplexed frame (step ST12 of FIG. 12).

[Relation of Expiration Value of Timer and Division Size]

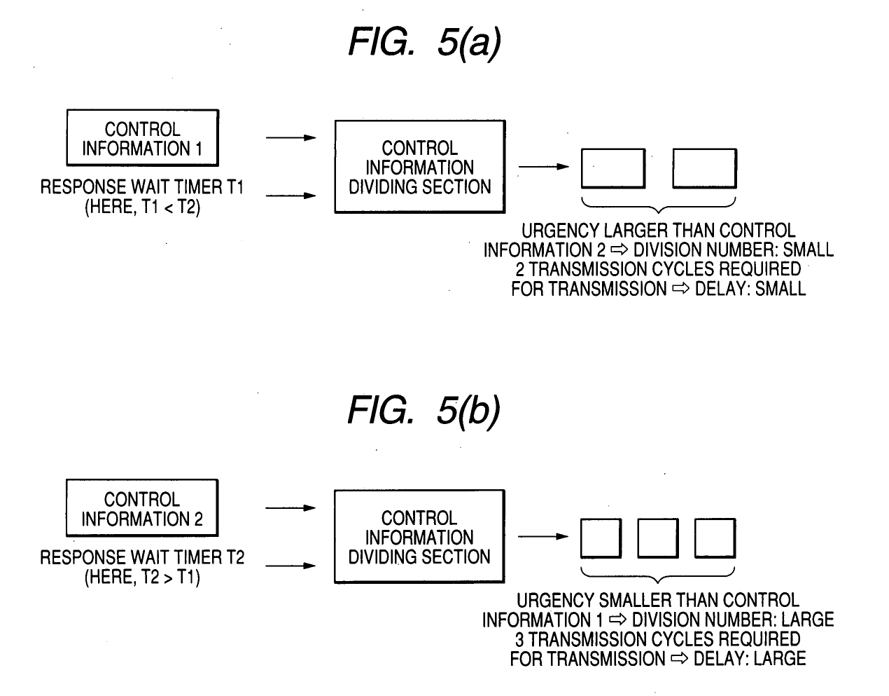

As shown in FIG. 5, control information is divided in such a manner that, the smaller the expiration value of the timer is, the more a division size is enlarged (FIG. 5(a)), and the more the expiration value of the timer is, the more the division size is reduced (FIG. 5(b)). That is, the control information dividing section 13 considers that control information, in which an expiration value of a response wait timer is small, requires an immediate response (or as described above, it is a response itself to the received control information), and divides in such a manner that transmission delay is reduced.

On one hand, it considers that control information, in which an expiration value of a response wait timer is large, does not require such an immediate response (or, as described above, it is a notification and an instruction which do not require a response from an opposite station), and it divides in such a manner that transmission delay is allowed.

[Division of Control Information During Period of Sending/Receiving Call]

Meanwhile, since transmission/reception of media information is not carried out during a period of sending/receiving a call, it is possible to utilize an entirety of a multiplexed frame as an area for transmitting control information. Therefore, the control information dividing section 13, in case that a size of control information at the time of sending/receiving a call exceeds a size of a multiplexed frame, divides in such a manner that it becomes a size which is equivalent to that of the multiplexed frame. Therefore, the above-described terminal capability information (in case that it is larger than a size of the multiplexed frame) is divided so as to become equal to a size of the multiplexed frame.

In addition, the control information dividing section 13 outputs a division size to the encoding method selecting section 14, before it outputs a one head piece among the divided control information to the multiplexing section 15. Further, the control information dividing section 13, when it completed to output all of the divided control information to the multiplexing section 15 (step ST13 of FIG. 2), outputs a division size=0, to the encoding method selecting section 14 (step ST14 of FIG. 2).

[Combination of Encoding Method and Transmission Rate is Selected]

The encoding method selecting section 14, when a division size of control information is inputted thereto from the control information dividing section 13 (step ST6 of FIG. 2), selects such combination of an encoding method and a transmission rate that it is possible to transfer sounds/images at maximum transfer efficiency within a range which is obtained by subtracting a division size of control information from a size of a multiplexed frame, among the combinations notified to an opposite station at the time of sending/receiving a call (step ST7 and step 15 of FIG. 2), and instructs the encoding section 11 so as to change over to the selected encoding method (step ST8 and step 16 of FIG. 2).

The encoding section 11 interrupts encoding of media information by the encoding method which is now being used, at that time (step ST9 and step 17 of FIG. 2), and changes over to the encoding method as instructed from the encoding method selecting section 14 (step ST10 and step 18 of FIG. 2), and then, resumes encoding of media information (step ST11 and step 19 of FIG. 2).

Meanwhile, the above-described changeover processing of an encoding method (each step from ST8 until ST11 and each step from ST16 until ST19 in FIG. 2) is carried out only in case that the encoding method selecting section 14 selected an encoding method which is different from a thing which is now being used by the encoding section 11. In addition, a series of processing from outputting of a division size of control information until change over of an encoding method (each step from ST6 until ST11 and each step from ST14 until ST19 in FIG. 2) is carried out only during a period of call (i.e., when there exists media information which can be encoded/multiplexed and transmitted to an opposite station).

The multiplexing section 15 multiplexes control information which was inputted from the control information dividing section 13 and each media information which was inputted from the encoding section 11, and adds header information thereto (an identification number of a multiplexing table, which will be described later, is set up in the header information), and then, transmits it to an opposite station through the communication network 30.

[Concrete Example of Changeover of Encoding Method and Multiplexing Processing]

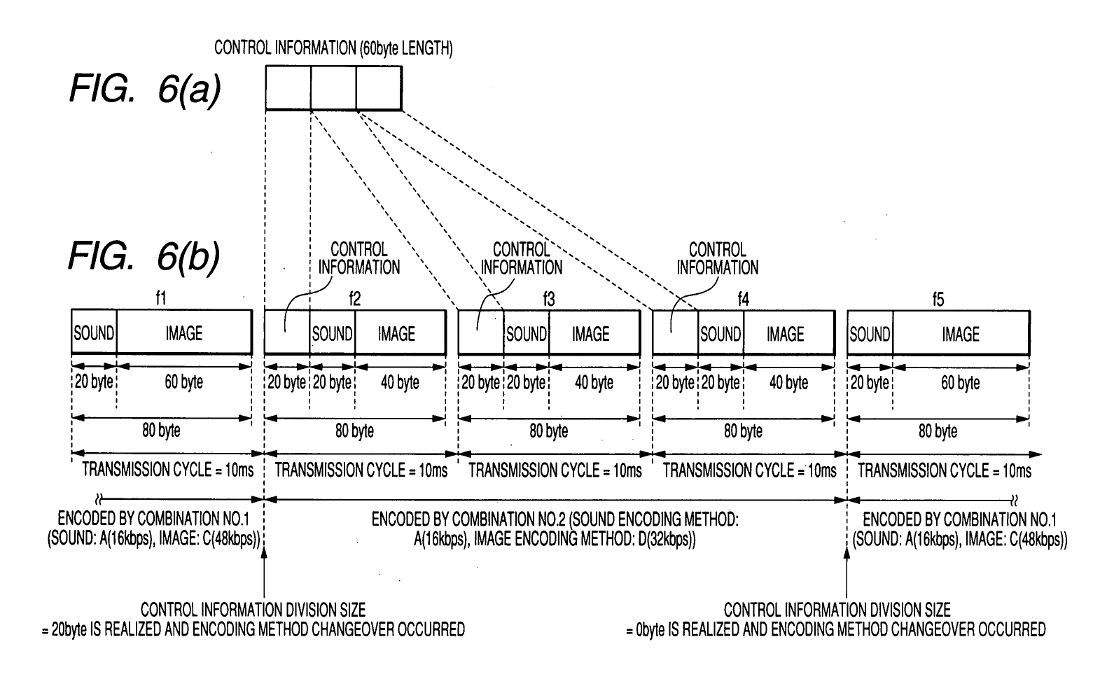

The above-described series of processing procedures of changeover of an encoding method and multiplexing will be described over citing a concrete example. FIG. 6 shows a configuration of a multiplexed frame to be transmitted. Here is considered such a case that, as shown in FIG. 6(b), combination of an encoding method and a transmission rate shown in FIG. 4 was notified to an opposite station at the time of sending/receiving a call, under such an environment that one transmission cycle is 10 milliseconds and a size of a multiplexed frame to be transmitted per one transmission cycle is 80 bytes.

When there exists no control information to be transmitted under the environment as described above, it is possible to use an entire multiplexed frame of a 80 byte length for transmission of sounds/images (f1 of FIG. 6(b)). Among what is shown in FIG. 4, maximum information quantity within a range of the 80 byte length per 10 millisecond, is obtained by combination of an encoding method and a transmission rate in No. 1, and therefore, when there exists no control information to be transmitted, sounds are encoded by an encoding method A (16 kbps) and images are encoded by an encoding method C (48 kbps).

Here is considered such a case that, as shown in FIG. 6(a), the control information preparing section 12 prepares control information of a 60 byte length and the control information dividing section 13 divided the above-described control information by a 20 bype length (i.e., 60.20=3 divisions) (f2, f3, f4 of FIG. 6(b)). The control information dividing section 13 outputs a division size=20 bytes, to the encoding method selecting section 14, before it outputs a first one piece of the three divided control information to the multiplexing section 15.

The encoding method selecting section 14 considers at that time that an area, which is available for transmission of sounds/images, in a multiplexed frame, is of 80−20=60 byte length, and selects combination of an encoding method and a transmission rate for maximizing information quantity of sounds/images within that range,

Among what is shown in FIG. 4, maximum information quantity within the range of a 60 byte length per 10 millisecond is obtained by combination of an encoding method and a transmission rate in No. 2, and therefore, at this time, the encoding method selecting section selects A (16 kbps) as an encoding method of sounds, and selects D (32 kbps) as an encoding method of images, and instructs the encoding section 11 so as to change over the above-described encoding methods.

In addition, the control information dividing section 13, when it completes to output a final third piece of the three divided control information to the multiplexing section 15, outputs a division size=0 byte to the encoding method selecting section 14, and therefore, the encoding method selecting section 14 selects, at that time, the sound encoding method A (16 kbps) at the time that there exists no control information to be transmitted and the image encoding method C(48 kbps), and instructs the encoding section 11 on changeover. By doing so, after transmission completion of control information, it becomes possible to use an entire multiplexed frame of a 80 byte length for transmission of sounds/images (f5 of FIG. 6(b)).

Meanwhile, as described later, in the reception side apparatus 20, in order to de-multiplex a received multiplexed frame and decode de-multiplexed media information, header information, which was added to the multiplexed frame, is utilized, and therefore, as in the method described in the JP-A-11-313048, there is no need to carry out multiplexing by adding control information which shows a changed encoding method, when an encoding method of sounds/images or a transmission rate fluctuated.

[Flow of Processing of Reception Side Apparatus During Period of Call]

A flow of processing of the reception side apparatus 20 during a period of call will be hereinafter described. The de-multiplexing section 21, when it receives a multiplexed frame from an opposite station through the communication network 30 (step ST1 of FIG. 3), obtains a ratio of information quantity of sound/image/control information included in the multiplexed frame, on the basis of header information added to the multiplexed frame.

In a television telephone apparatus implemented in relation to the recommendation described in the ITU-T Recommendation H.223, an identification number, which was associated with information called as a multiplexing table which represents a ratio of sound/image/control information included in a multiplexed frame, is set up and added as header information, on the occasion that the transmission side apparatus multiplexes sound/image/control information. The above-described information relating to the multiplexing table and the identification number is exchanged with an opposite station by control information called as Multiplex Entry Send which is defined in the recommendation described in the ITU-T Recommendation H.245.

[Divided Control Information is Combined]

The de-multiplexing section 21, then, de-multiplexes the multiplexed frame and outputs media information to the decoding section 25. On that occasion, in case that control information is included in the multiplexed frame, it outputs the control information in a divided state, to the control information combining section 22 (step ST3 of FIG. 3). The control information combining section 22 keeps the control information in a divided state, which was inputted from the de-multiplexing section 21, and combines it into one complete control information, and outputs it to the control information analyzing section 24 (step ST4 of FIG. 3).

In a television telephone apparatus implemented in relation to Annex C.8.1 of the ITU-T Recommendation H.324, an area of a one byte length, which is called as Last Segment Field, is added to the control information in a divided state, and if all bits are set to 1, it is considered to be a final factor which configures the control information, and therefore, it is all right if the control information combining section 22 considers that all factors, which configure the control information, are prepared, when it detected that all bits of the above-described Last Segment Field are set to 1, and combines the control information in a divided state in the order of inputting from the de-multiplexing section 21, and outputs it to the control information analyzing section 24.

[Changeover Processing of Encoding Method]

In addition, in case that it became clear that each media information quantity, which is included in the multiplexed frame received this time, is different from each media information quantity which was included in the multiplexed frame received previous time, it is considered that there occurred changeover of an encoding method of these media information in a transmission side apparatus at an opposite station, and an output of media information to the decoding section 25 is suspended (step ST6 of FIG. 3), and decoding method changeover processing as described below is carried out.

The de-multiplexing section 21 outputs information quantity of each media information other than control information, to the decoding method selecting section 23 (step ST7 of FIG. 3). The decoding method selecting section 23 selects a decoding method which is appropriate for decoding each media information, when information quantity of each media information is inputted from the de-multiplexing section 23 (step ST8 of FIG. 3).

Next, the decoding section 25 is instructed so as to change over from the decoding method which is now being used to the selected decoding method (step ST9 of FIG. 3). The decoding section 25, when changeover to the decoding method as instructed by the decoding method selecting section 23 is completed (step ST10 of FIG. 3), outputs a notification of changeover completion to the decoding method selecting section 23 (step ST11 of FIG. 3).

The decoding method selecting section 23 considers that preparation for correctly decoding the de-multiplexed media information was completed, when a notification of changeover completion was inputted from a decoding section of all media information, and instructs the de-multiplexing section 21 so as to resume outputting of media information to the decoding section 25 (step ST12 of FIG. 3).

[Concrete Example of Selection and Changeover of Decoding Method]

As an example, it will be described how changeover and selection of a decoding method will be carried out concretely, in case that a transmission cycle of a multiplexed frame is 10 milliseconds and combination of an encoding method and a transmission rate as shown in FIG. 4 is notified from an opposite station at the time of sending/receiving a call.

In case that sounds and images are included in a multiplexed frame which was received by the de-multiplexing section 21 from an opposite station previous time, with a ratio of 20 bytes in sounds and 60 bytes in images and control information, sounds and images were included in a multiplexed frame which was received from an opposite station this time, with a ratio of 20 bytes in control information, 20 bytes in sounds and 40 bytes in images, it is judged that media information quantity fluctuated, and the decoding method selecting section 23 selects a decoding method suitable for decoding these media information.

Since sounds and images, which are transmitted during a period of 10 milliseconds, become 20 bytes, and 40 bytes respectively, when combination of an encoding method and a transmission rate in No. 2 of FIG. 4 was selected by a transmission side apparatus of an opposite station, the decoding method selecting section 23 selects A(16 kbs) as a method for decoding sounds, and selects D(32 bps) as a method for decoding images, and instructs changeover to the decoding section 25.

The reception side apparatus 20 carries out de-multiplexing of a multiplexed frame which was received by the method as described above and decoding of media information, and therefore, can carry out correctly de-multiplexing/decoding, without multiplexing control information which shows a changed encoding method additionally by the transmission side apparatus 10, as in the method described in the JP-A-11-313048.

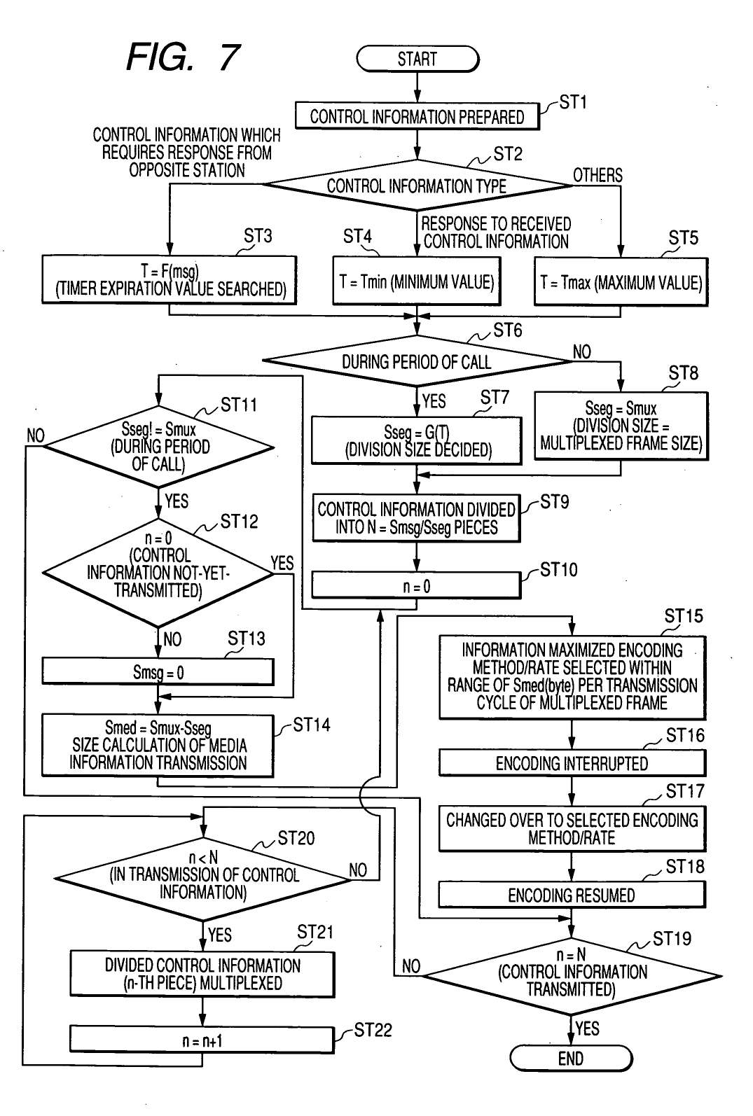

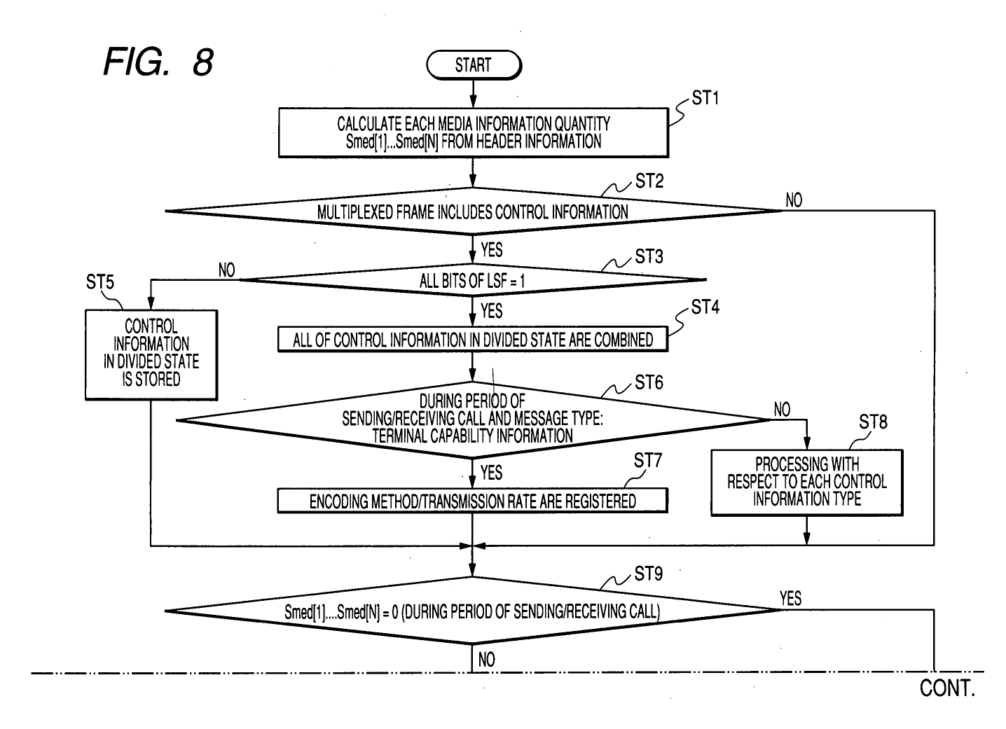

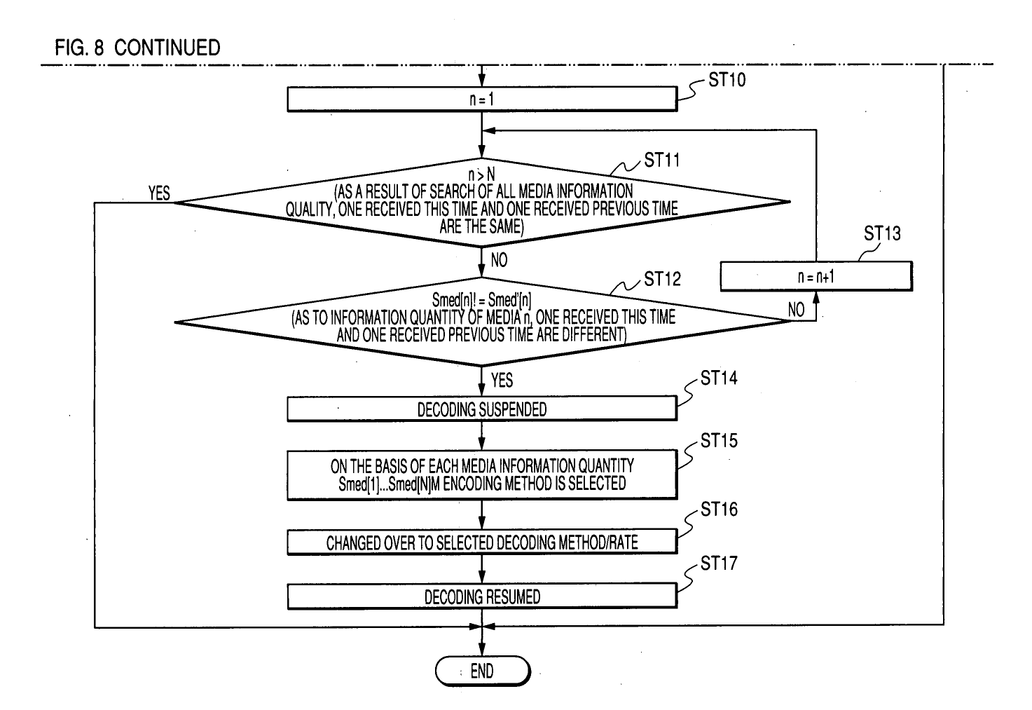

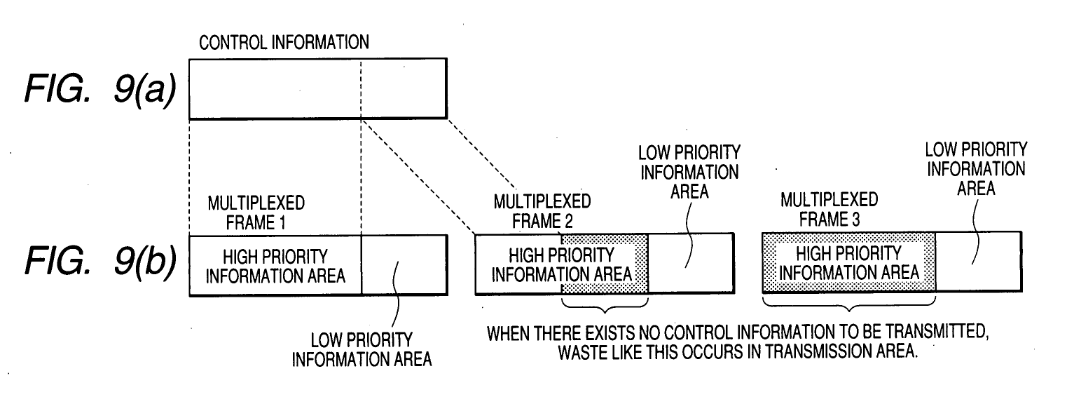

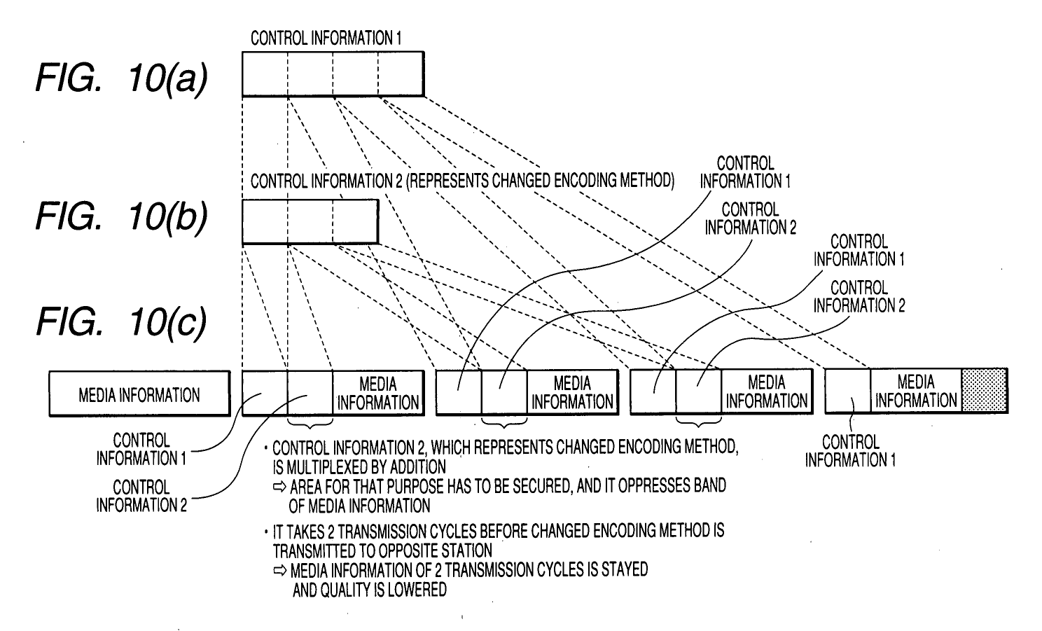

Hereinafter, a program, which relates to the best mode form carrying out the invention, will be described in detail with reference to drawings. FIG. 7 is a flow chart which represents transmission side processing of the program which relates to this mode, and FIG. 8 is a flow chart which represents reception side processing of the program which relates to this mode.

[Flow Chart of Transmission Side Processing]

The transmission side processing will be described with reference to FIG. 7. A transmission side of the program which relates to this mode prepares appropriate control information when there occurs the need to transmit control information to an opposite station at any momentum (step ST1 of FIG. 7). Here, if it is in such a state that combination of an encoding method and a transmission rate of media information which can be used during a period of call has not yet notified, particularly at the time of sending/receiving a call, all of these combinations of encoding methods and transmission rates of media information are set up in control information which shows terminal capability information (which is comparable to Terminal Capability Set defined in the ITU-T Recommendation H.245.

[Saturation Value of Response Wait Timer is Stored in Variable T]

Next, depending on a type of prepared control information (step ST2 of FIG. 7), a saturation value of a response wait timer is stored in a variable T as follows. If the prepared control information is one which requires a response from an opposite station, an saturation value of a timer which was associated with respect to each type of control information (citing control information defined in the ITU-T Recommendation H.245 as an example, when Terminal Capability Set was prepared, T101, and when Open Logical Channel was prepared, T103) is stored in the variable T (step ST3 of FIG. 7).

[Case that Prepared Control Information is Response]

In case that the prepared control information is a response itself to received control information (citing control information defined in the ITU-T Recommendation H.245 as an example, in case that it is Terminal Capability Set Ack and Open Logical Channel Ack etc., a minimum value Tmin, which the variable T can take, is stored (step ST4 of FIG. 7). By doing so, the control information is divided in such a manner that transmission delay becomes minimum, as described later.

[Case that Prepared Control Information does not Require Response]

In case that the prepared control information is used as a notification and an instruction which do not require a response from an opposite station (citing control information defined in the ITU-T Recommendation H.245 as an example, H223 Skew Indication and End Session Command etc. are comparable to this), a maximum value Tmax, which the variable T can take, is stored (step ST5 of FIG. 7). By doing so, the control information is divided in such a manner that transmission delay becomes maximum (influence to sounds/images is suppressed to the minimum, by that much), as described later.

[Division Size of Control Information During Period of Call is Decided]

Next, a division size Sseg of control information is obtained as follows, depending on whether it is during a period of sending/receiving a call or during a period of call (step ST6 of FIG. 7). In case that it is during a period of call, a division size Sseg of control information is obtained in such a manner that it becomes a relation of an inverse correlation with a timer expiration value stored in the variable T (step ST7 of FIG. 7). Here, G(T) represents processing of outputting a value of an inverse correlation with the variable T.

[Relation of Expiration Value of Response Wait Timer of Division Size]

As shown in FIG. 5, control information is divided in such a manner that, the smaller an expiration value of a timer is, the more a division size is enlarged, and the larger the expiration value of the timer is, the more a division size is reduced. That is, the control information dividing section 13 considers that control information, in which an expiration value of a response wait timer is small, requires an immediate response (or, as described above, it is a response itself to received control information), divides it in such a manner that transmission delay is reduced.

On one hand, it considers that control information, in which an expiration value of a response wait timer is large, doe not require such an immediate response (or, as described above, it is a notification and an instruction which do not require a response from an opposite station), and divides it in such a manner that transmission delay is allowed.

[Division Size During Period of Sending/Receiving Call is Made Equal to that of Multiplexed Frame]

In case that it is during a period of sending/receiving a call, transmission/reception of media information are not carried out, and therefore, it is possible to utilize an entirety of a multiplexed frame as an area for transmitting control information. Therefore, a division size Sseg of control information is set to Smux which is equivalent to that of a multiplexed frame (step ST8 of FIG. 7). The prepared control information is divided by a Sseg byte length, in accordance with the division size obtained as above. Here, a division number is stored in the variable N (step ST9 of FIG. 7).

[Changeover of Encoding Method of Media Information]

When control information is multiplexed, an area of media information in a multiplexed frame is reduced, and therefore, changeover of an encoding method of media information is carried out as follows, after control information was divided. Meanwhile, transmission/reception of media information is carried out to/from an opposite station only during a period of call, and therefore, processing is branched depending on states of whether it is during a period of call or during a period of sending/receiving a call (step ST11 of FIG. 7), and changeover of an encoding method is to be carried out only during a period of call. Here, in case that the division size Sseg of control information is different from the size Smux of a multiplexed frame, it is considered to be during a period of call.

In case that it is during a period of call, a size Smed of an area which is available for transmitting media information in a multiplexed frame is obtained by subtracting the division size Sseg of control information from the size Smux of a multiplexed frame (step ST14 of FIG. 7). Next, within a range of Smed, such combination of an encoding method and a transmission rate that it is possible to transmit sounds/images with maximum transmission efficiency is selected from combinations which were notified to an opposite station at the time of sending/receiving a call (step ST16 of FIG. 7), and encoding of each media information by an encoding method which is now being used is interrupted (step ST16 of FIG. 7). When encoding was interrupted, it is changed over to the selected encoding method and transmission rate (step ST17 of FIG. 7), and encoding is resumed (step ST18 of FIG. 7).

When encoding method changeover of media information is completed, control information, which was divided into N pieces, is multiplexed with media information one by one with respect to each transmission cycle of a multiplexed frame and is transmitted (from step S20 to step ST22 of FIG. 7). Here, n designates a transmission counter of the divided control information and it is added one by one every time one of the divided control information is multiplexed (step ST22 of FIG. 7), and it is initialized to 0 (step ST10 of FIG. 7) before the above-described encoding method changeover (from step ST11 to step ST18 of FIG. 7).

When it is completed to multiplex all of the control information which was divided into N pieces (branched to No in step ST20 of FIG. 7. That is, a value of the counter n reaches to N), an area of medial information in a multiplexed frame is expanded, and therefore, the above-described (from step ST11 to step ST18 of FIG. 7) encoding method changeover processing is carried out again.

In case that it is during a period of call (branched to Yes in step ST11 of FIG. 7), a value of the counter n reached to N (branched to No in step ST12 of FIG. 7. That is, control information transmission completion), and therefore, a division size Sseg of control information is set to 0 (step ST13 of FIG. 7), and on the basis of the updated division size Sseg, changeover of an encoding method and a transmission rate is carried out again, and in consequence, transmission quality of media information is returned to equivalence prior to transmission of control information.

[Concrete Example of Selection and Changeover of Encoding Method]

For example, in case that combination of an encoding method and a transmission rate is notified to an opposite station at the time of sending/receiving a call, under such an environment that a transmission cycle of a multiplexed frame is 10 millisecond and a size of a multiplexed frame to be transmitted per one transmission cycle is 80 bytes and control of a 60 byte length is prepared and it is divided by a 20 byte length (i.e., 60÷20=3 divisions), in the same manner as that explained in the example of the transmission side apparatus of the multiplexed transmission apparatus which relates to the invention, A(16 kbps) is to be selected and changed over as an encoding method of sounds, and D(32 kbps) is to be selected and changed over as an encoding method of images.

Even after it was completed to multiplex/transmit all of three-divided control information, in the same manner as that explained in the example of the transmission side apparatus of the multiplexed transmission apparatus which relates to the invention, A(16 kbps) is to be selected and changed over as an encoding method of sounds, and C(48 kbps) is to be selected and changed over as an encoding method of images. Line the above-described example, a configuration of the transmitted multiplexed frame becomes as shown in FIG. 6, in the same manner.

Meanwhile, as described later, on the reception side of the program which relates to this mode, in order to de-multiplex the received multiplexed frame and decode the de-multiplexed media information, header information, which was added to the multiplexed frame, is utilized, and therefore, as in the method described in the JP-A-11-313048, there is no need to carry out multiplexing by adding control information which shows a changed encoding method, when an encoding method of sounds/images or a transmission rate fluctuated.

[Flow Chart of Reception Side Processing]

Processing on the reception side will be described with reference to FIG. 8. A reception side of the program which relates to this mode, when it receives a multiplexed frame from an opposite station through a communication network, calculated information quantity of each media from header information and stores it in an array Smed[1], . . . Smed[N] (step ST1 of FIG. 8). Here, Smed[n] represents an array factor for storing information quantity of media information n.

[In Case that All Bits of LSF are 1, All Control Information is Combined]

In case that control information was included in the multiplexed frame (branched to Yes in step ST2 of FIG. 8), it is shifted to reception processing of control information as shown below. In case that all bits of Last Segment Field described in Annex C.8.1 of the ITU-T Recommendation H.324, which is added to the control information, were set up to 1 (branched to Yes in step ST3 of FIG. 8), it is considered that all factors, which configure one complete control information, were prepared, and maintained control information in a divided state is all combined (step ST4 of FIG. 8) to carry out processing depending on a content of the control information (from step ST6 to step ST8 of FIG. 8).

Particularly in case that it is a state of sending/receiving a call and control information represents terminal capability information of an opposite station (branched to Yes in step ST6 of FIG. 8), combinations of encoding methods/transmission rates, which were set up to the information, are all held up to the time of clearing a call (step ST7 of FIG. 8). As described later, at the time of decoding method selection and changeover of de-multiplexed each media information, these combinations of encoding methods/transmission rates are referred.

[In Case that All Bits of LSF are not 1, Divided Control Information is Maintained]

In case that all bits of Last Segment Field described in Annex C.8.1 of the ITU-T Recommendation H.324, which are added to the de-multiplexed information, are not set up to 1 (branched to No in step ST3 of FIG. 8), it is considered that all factors, which configure one complete control information, were not prepared, and the control information is maintained until control information in which all bits are 1 is received (step ST5 of FIG. 8).

[Whether it is During Period of Sending/Receiving Call or During Period of Call is Judged]

In case that reception processing of control information as described above (from step ST3 to step ST8 of FIG. 8) is completed, or control information is not included in a received multiplexed frame (branched to No in step ST2 of FIG. 8), processing is branched depending on a sate of whether it is during a period of sending/receiving a call or during a period of call, and if it is during a period of sending/receiving a call (if media information is not included in a multiplexed frame, it is considered that it is during a period of sending/receiving a call. Branched to Yes in step ST9 of FIG. 8), processing is finished as it is. If it is during a period of call (if media information is not included in a multiplexed frame, it is considered that it is during a period of call. Branched to No in step ST9 of FIG. 8), it is shifted to decoding method selection/changeover processing as shown below.

[Decoding Method Selection/Changeover Processing]

A reception side, when each media information is de-multiplexed, compares quantity of information received previous time and quantity of information received this time from media information 1 by rotation, in order to investigate whether the media information can be correctly decoded by a decoding method which is now being used (from step ST10 to step 13 of FIG. 8). Here, Smed′[n] represents an array factor for storing information quantity of media information n received previous time.

[Case that Media Information is the Same as One Received Previous Time]

In case that, as to all media information, results of comparing quantity of information received previous time and quantity of information received this time were the same (branched to Yes of step ST11 of FIG. 8), it is judged that there occurs no encoding method changeover of media information on a reception side of an opposite station (i.e., there is also no need to change over a decoding method on a reception side), and processing is finished as it is, and decoding of media information is continued without change.

[Case that Media Information is Different from One Received Previous Time]

If there is such media information that quantity of information received this time is different from quantity of information received previous time, as a result of comparison (branched to Yes in step ST12 of FIG. 8), it is judged that there occurred encoding method changeover of media information on a transmission side of an opposite station (i.e., there is also need to change over a decoding method on a reception side), and decoding is suspended (step ST14 of FIG. 8), and on the basis of information quantity of each media information which was de-multiplexed this time, Smed[1], . . . Smed[N], appropriate combination of a decoding method and a transmission rate is selected from combinations of decoding methods and transmission rates, which were notified from an opposite station during a period of sending/receiving a call (step ST15 of FIG. 8). Next, a decoding method and a transmission rate are changed over to the selected one (step ST16 of FIG. 8), and when changeover was completed, decoding is resumed (step ST17 of FIG. 8) and processing is completed.

[Concrete Example of Selection and Changeover of Decoding Method]

As an example, how concretely selection and changeover of a decoding method will be carried out in case that a transmission cycle of a multiplexed frame is 10 milliseconds and combinations of encoding methods and transmission rates as in FIG. 4 are notified at the time of sending/receiving a call, will be described.

In case that sounds and images are included in a multiplexed frame which was received from an opposite station previous time with a ratio of 20 bytes in sounds and 60 bytes in images and control information, sounds and images are included in a multiplexed frame which was received this time, with a ratio of 20 bytes in control information/20 bytes in sounds/40 bytes in images, the decoding method selecting section 23 selects A(16 kbps) as a method for decoding sounds and D(32 kbps) as a method for decoding images and carries out changeover, in the same manner as described in the example of the reception side apparatus of the multiplexed transmission apparatus which relates to the invention.

A reception side of a program, which relates to this mode, carries out de-multiplexing of a received multiplexed frame and decoding of media information by the method as described above, and therefore, it is possible to correctly carry out de-multiplexing/decoding without additional multiplexing of control information which shows a changed encoding method, on a transmission side, as in the method described in the JP-A-11-313048.

A multiplexed transmission method, a multiplexed transmission apparatus, its software and recording medium of the invention have control information dividing sections which can adjust its transmission delay depending on urgency of control information, and encoding method selecting sections which effectively utilize a transmission band within a range except control information, to the maximum extent possible, and are useful for maintaining quality of media information such as sound quality/image quality as high as possible, even in such a state that control information is frequently generated by, for example, addition/deletion of media information and adjustment of image quality during a period of call, in a television telephone. In addition, a multiplexed transmission method and apparatus in a television telephone, which relates to the invention, are applicable to an application of a television conference system etc. implemented in relation to a recommendation which is the same as that of the television telephone.

What is claimed is:

1. A multiplexed communication method which multiplexes a frame having media information and control information to transmit and receive it, comprising the steps of:
dividing the control information, depending on a length of response wait available which is defined with respect to each control information;
securing a size of the control information which was divided in the dividing step, in the frame; and
encoding the media information such that a size of the media information after encoding becomes equal to or less than a size which is obtained by subtracting a size secured in the securing step from a size of the frame.

2. The multiplexed communication method according to claim 1, wherein the shorter a length of the response wait available time is, the more the dividing step enlarges a size of the control information which is divided in the dividing step.

3. The multiplexed communication method according to claim 2, wherein, as to the dividing step, in case that the control information which is transmitted, is not required to be received, a size of the divided control information is made smaller than such a case that the control information which is transmitted, is required to be received.

4. The multiplexed communication method according to claim 1, further comprising the steps of:
deciding one encoding method among one or more encoding methods which are available on the occasion of encoding the media information, on the basis of a size of the media information;
transmitting the control information including information which shows the one encoding method decided in the deciding step;
restraining decoding of the media information, in case that a size of the media information is different from a size of already received media information, when the media information is received;
selecting a decoding method, on the basis of the control information including the information which shows the one encoding method transmitted in the transmitting step; and
decoding the restrained media information, by use of the selected decoding method, after the decoding method is selected in the step of selecting the decoding method.

5. A multiplexed communication apparatus which multiplexes a frame having media information and control information to transmit and receive it, comprising:
a control information generating section which generates the control information;
a control information dividing section which divides the control information, depending on a length of a response wait available time which is defined with respect to each control information;
an encoding method selecting section which selects such an encoding method that a size of the media information after encoding becomes equal to or less than a size which is obtained by subtracting a size of the control information divided in the control information division section from a size of the frame; and
a multiplexing section which multiplexes the encoded media information and the divided control information, by the encoding method which is selected in the encoding method selecting section.

6. The multiplexed communication apparatus according to claim 5; wherein the shorter a length of the response wait available time is, the more the control information dividing section enlarges a size of the divided control information.

7. The multiplexed communication apparatus according to claim 6, wherein the control information dividing section reduces a size of the divided control information more in case that the control information to be transmitted is not necessary to be received, than in case that the control information to be transmitted is necessary to be received.

8. The multiplexed communication apparatus according to claim 5, wherein the encoding method selecting section selected one encoding method, among one or more encoding method which are available on the occasion of encoding the media information.

9. The multiplexed communication apparatus according to claim 8, comprising:
a decoding method selecting section which restrains decoding the media information, in case that a size of the media information is different from a size of already received media information, when the media information is received, and selects a decoding method, on the basis of the control information including information which shows the one encoding method selected in the encoding method selecting section; and
a decoding section which decodes the media information and the control information, by use of a decoding method which was selected in the decoding method selecting section.

10. A multiplexed communication program for having a computer executed each step which is described in claim 1.

11. A recording medium for storing the multiplexed communication program as set forth in claim 10.
